(19) United States
(12) Patent Application Publication
(10) Pub. No.: US 2026/0304250 A1
(43) Pub. Date: Oct. 1, 2026

(54) APPARATUS AND METHOD FOR HANDLING LOWER LAYER TRIGGERED MOBILITY IN A WIRELESS COMMUNICATION SYSTEM

(71) Applicant: SAMSUNG ELECTRONICS CO., LTD., Gyeonggi -do (KR)

(72) Inventors: Aby Kanneath ABRAHAM, Kamataka (KR); Seungri JIN, Gyeonggi-do (KR)

(21) Appl. No.: 19/478,451

(22) PCT Filed: Apr. 24, 2024
(86) PCT No.: PCT/KR2024/005526

§ 371 Date: Oct. 24, 2025

(30) Foreign Application Priority Data
Apr. 24, 2023 (IN) 202341029473
Apr. 8, 2024 (IN) 202341029473

(51) Int. Cl. H04W 36/00; H04W 36/30; H04W 36/32

(52) U.S. Cl. CPC H04W 36/0072; H04W 36/00835; H04W 36/324; H04W 36/305

(57) ABSTRACT

The disclosure relates to a 5G or 6G communication system for supporting a higher data transmission rate. Specifically, the disclosure related to a method for handling LTM in a wireless network. The method includes receiving, by a UE, a LTM configuration comprising a LTM candidate configuration for at least one candidate cell of plurality of candidate cells, and an LTM-reference configuration from a network apparatus, wherein the LTM candidate configuration is not a complete configuration, wherein the complete configuration is a RRC message applied directly at a LTM cell switch. The UE determines whether the received LTM-reference configuration is set to setup or release for the at least one candidate cell of the plurality of candidate cells. When the received LTM-reference configuration is set to setup in the UE, the UE replaces or stores the received LTM-reference configuration. When the received LTM-reference configuration is set to release, the UE deletes the LTM-reference configuration available in the UE.

### TECHNICAL FIELD

The present disclosure relates to a wireless communication systems and, more specifically, the present disclosure relates to handling Lower Layer (L1/L2) Triggered Mobility (LTM) in a wireless communication system.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

The present disclosure relates to a wireless communication systems and, more specifically, the present disclosure relates to handling Lower Layer (L1/L2) Triggered Mobility (LTM) in a wireless communication system.

### Solution to Problem

In one aspect the objects are achieved by providing a method for handling LTM in a wireless network. The method includes receiving, by a UE, a LTM configuration comprising a LTM candidate configuration for at least one candidate cell of plurality of candidate cells, and an LTM-reference configuration from a network apparatus, wherein the LTM candidate configuration is not a complete configuration, wherein the complete configuration is a RRC message applied directly at a LTM cell switch. The UE determines whether the received LTM-reference configuration is set to setup or release for the at least one candidate cell of the plurality of candidate cells. When the received LTM-reference configuration is set to setup in the UE, the UE replaces or stores the received LTM-reference configuration. When the received LTM-Reference configuration is set to release, the UE deletes the LTM-reference configuration available in the UE.

In an embodiment, the method includes determining, by the UE, whether the UE configuration comprises the LTM-reference configuration, wherein the single LTM reference configuration is applicable for all the non-complete candidate cell configurations. When the UE configuration comprises the LTM-reference configuration, the UE replaces the LTM-reference configuration in the UE configuration with the received LTM-reference configuration, and regenerates and stores a RRC reconfiguration message for the at least one candidate cell of the plurality of candidate cells by applying the LTM candidate configuration and the LTM reference configuration, wherein the RRC reconfiguration message is applied at the time of LTM cell switch to the candidate cell. When the UE configuration does not comprise the LTM-reference configuration, the UE stores the received LTM-reference configuration in the UE for the at least one candidate cell of the plurality of candidate cells, and generates and stores the RRC reconfiguration message for the at least one candidate cell of the plurality of candidate cells by applying the LTM candidate configuration and the LTM reference configuration.

In an embodiment, deleting, by the UE, the LTM-reference configuration available comprises deleting the RRC reconfiguration message generated by applying the LTM reference configuration, when the received LTM-reference configuration is set to release.

In an embodiment, the method comprises applying the RRC reconfiguration message when the UE executes the LTM cell switch upon receiving a cell switch command from the network apparatus in MAC-CE or upon selecting a LTM candidate cell after radio link failure.

In another aspect the objects are achieved by providing a method for handling the LTM in the wireless network. The method includes creating by the network apparatus, the LTM configuration comprising at least one LTM candidate configuration for at least one candidate cell of plurality of candidate cells to the UE. The network apparatus determines whether the at least one LTM candidate configuration is not a complete configuration, wherein in the complete configuration is a RRC message applied directly at the LTM cell switch. The network apparatus includes the LTM-reference configuration in the LTM configuration when at least one LTM candidate configuration is not a complete configuration. Further, the method includes transmitting, by the network apparatus, the LTM configuration for the at least one candidate cell of the plurality of candidate cells for which the LTM candidate configuration is not the complete LTM configuration to the UE, wherein the LTM configuration comprises the LTM-reference configuration.

In an embodiment, the network apparatus releases the LTM candidate configuration upon releasing the LTM-reference configuration, wherein the LTM candidate configuration is not a complete configuration.

In an embodiment, the network apparatus configures the UE to maintain the LTM-reference configuration when the at least one LTM candidate configuration is configured in the UE, wherein the at least one LTM candidate configuration is not a complete configuration.

In another aspect the objects are achieved by providing a UE for handling the LTM in the wireless network. The UE includes a memory, a processor, an I/O interface and a LTM controller coupled to the memory, the I/O interface and the processor. The LTM controller receives the LTM configuration comprising the LTM candidate configuration for at least one candidate cell of plurality of candidate cells, and an LTM-reference configuration from a network apparatus, wherein the LTM candidate configuration is not a complete configuration, wherein the complete configuration is the RRC message applied directly at the LTM cell switch. The LTM controller determines whether the received LTM-reference configuration is set to setup or release for the at least one candidate cell of the plurality of candidate cells. When the received LTM-Reference configuration is set to setup in the UE, the LTM controller replaces or stores the received LTM-reference configuration. When the received LTM-reference configuration is set to release, the LTM controller deletes the LTM-reference configuration available in the UE.

In another aspects the objects are achieved by providing a network apparatus for handling the LTM in the wireless network. The network apparatus includes a memory, a processor, an I/O interface and a LTM controller coupled to the memory, the I/O interface and the processor. The LTM controller creates the LTM configuration comprising at least one LTM candidate configuration for at least one candidate cell of plurality of candidate cells to the UE. The LTM controller determines whether the at least one LTM candidate configuration is not a complete configuration, wherein in the complete configuration is the RRC message applied directly at the LTM cell switch. The LTM controller includes the LTM-reference configuration in the LTM configuration when at least one LTM candidate configuration is not a complete configuration. Further, the LTM controller transmits the LTM configuration for the at least one candidate cell of the plurality of candidate cells for which the LTM candidate configuration is not the complete LTM configuration to the UE, wherein the LTM configuration comprises the LTM-reference configuration.

These and other aspects of the embodiments herein will be better appreciated and understood when considered in conjunction with the following description and the accompanying drawings. It is understood, however, that the following descriptions, while indicating preferred embodiments and numerous specific details thereof, are given by way of illustration and not of limitation. Many changes and modifications be made within the scope of the embodiments herein without departing from the spirit thereof, and the embodiments herein include all such modifications.

### BRIEF DESCRIPTION OF DRAWINGS

These and other features, aspects, and advantages of the present embodiments are illustrated in the accompanying drawings, throughout which like reference letters indicate corresponding parts in the various figures. The embodiments herein will be better understood from the following description with reference to the drawings, in which:

FIG. 1 is a sequence diagram that illustrates overall flow of LTM in wireless network, accordingly to embodiments as disclosed herein.

FIG. 2 is a block diagram of a UE for handling the LTM in the wireless network, accordingly to embodiments as disclosed herein;

FIG. 3 is a block diagram of a network apparatus for handling the LTM in the wireless network, accordingly to embodiments as disclosed herein;

FIG. 4 is a flow diagram illustrating the UE handling the LTM in the wireless network, accordingly to the embodiments as disclosed herein;

FIG. 5 is a flow diagram illustrating the network apparatus handling the LTM in the wireless network, accordingly to the embodiments as disclosed herein;

FIG. 6 is a block diagram of a terminal (or a user equipment (UE), accordingly to the embodiments as disclosed herein; and

FIG. 7 illustrates a block diagram of a base station, accordingly to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

In wireless technologies such as Fifth Generation (5G) New Radio (NR) technologies, mobility for devices, such as User Equipment (UEs), is achieved through a process known as cell reselection in an RRC_IDLE mode. Prior to the NR R17, the mobility was performed using a procedure called handover in an RRC_CONNECTED mode. Network-controlled mobility is applicable to the UEs in the RRC_CONNECTED mode and requires explicit Radio Resource Control (RRC) signaling to be triggered by a gNB (gNodeB) in the NR. The handover in the NR typically involves three steps: handover preparation, execution, and completion. The gNB configure the UE to report measurements and based on the reported measurements or based on its own understanding of the network topology, the gNB will send RRC reconfiguration message to handover the UE to another cell called target cell from a source cell. The UE accesses the target cell and sends a RRC reconfiguration complete message. Alternatively in 3^{rd} Generation Partnership Project (3GPP) NR release 16, the gNB configures the UE with execution conditions for triggering the handover and once the execution conditions are satisfied, the UE will move to the target cell and sends the RRC reconfiguration complete to the gNB. In all these methods, the UE performs the handover by sending layer 3 (RRC) messages which causes considerable signaling overhead and latency issues.

GPP release 18 is considering LTM to solve the signaling overhead and latency issues. As per the 3GPP, the goal of the LTM is to enable a serving cell change via L1/L2 signaling, in order to reduce the latency, overhead and interruption time. The network (gNB) configures the UE with multiple candidate cells to allow fast application of configurations for the candidate cells. The network further sends Medium Access Control-Control Element (MAC CE) or L1 signaling to dynamically switch the UE from a source cell to one of the configured candidate cells. The MAC CE (or L1 signaling) to dynamically switch from the source cell to candidate cell is known as LTM cell switch command. Further, the LTM can be triggered based on L1 measurements rather than L3 measurements. The UE may receive a LTM measurement configuration from the gNB which are L1 measurement configuration which tells the UE what to measure, how to report, what to report etc.

3GPP proposes to perform the LTM, without reset of the lower layers like MAC to avoid data loss and to reduce the additional delay of data recovery wherever it is possible. The gNB provides LTM candidate configuration, that is configure LTM candidate cells through one RRC reconfiguration message for a candidate target cell or through one cell group configuration (CellGroupConfig) for each candidate target cell or through any similar RRC structure or Information Element (IE) containing similar fields (for e.g. a new IE LTM-CandidateConfig can be defined as ASN.1 sequence containing CellGroupConfig and some other information elements in the RRCReconfiguration). The gNB may further release or modify the candidate configurations. A UE may store the LTM configuration of other candidate cells even after moving to a candidate cell through the LTM. The UE may also perform the LTM for recovering from a radio link failure, for e.g. the UE may select a LTM candidate cell and send the RRCReconfigurationComplete after applying the RRC message corresponding to the LTM candidate cell.

Thus, it is desired to address the above-mentioned disadvantages or other shortcomings or at least provide a useful alternative.

The embodiments herein and the various features and advantageous details thereof are explained more fully with reference to the non-limiting embodiments that are illustrated in the accompanying drawings and details in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples are not be construed as limiting the scope of the embodiments herein.

As is traditional in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and optionally be driven by firmware and software. The circuits, for example, be embodied in one or more semiconductor chips, or on substrate supports such as printed circuit boards and the like. The circuits constituting a block be implemented by dedicated hardware, or by a processor (e.g., one or more programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents and substitutes in addition to those which are particularly set out in the accompanying drawings. Although the terms first, second, etc. used herein to describe various elements, these elements are not be limited by these terms. These terms are generally used to distinguish one element from another.

The principal object of the embodiments herein is to provide a UE and method for handling LTM in a wireless network. The method includes handling a LTM reference configuration modification and release at the UE. The network indicates modification or release of the LTM reference configuration stored at the UE for candidate cells for which a LTM candidate configuration is not a complete LTM configuration. The LTM reference configuration is included in the LTM candidate configuration.

Another object of the embodiment herein is to provide a network apparatus and method for handling the LTM in the wireless network. The network apparatus determines whether the at least one LTM candidate configuration is not a complete configuration based on a LTM configuration complete message received from the UE. The network apparatus transmits the LTM candidate configuration for which the LTM candidate configuration is not the complete LTM configuration. The LTM reference configuration is included in the LTM candidate configuration.

Yet another object of the embodiment herein is to provide methods for configuring interruptions for LTM measurements. The UE indicates to the network whether interruption is needed for performing the LTM measurements for both inter frequency and intra-frequency LTM measurements without a gap. When the LTM measurement could be performed without a measurement gap, the UE indicates to network whether the LTM measurements could be performed without interruptions also.

Embodiments disclosed herein provide a method for handling LTM in a wireless network. The method includes receiving, by a UE, a LTM configuration comprising a LTM candidate configuration for at least one candidate cell of plurality of candidate cells, and an LTM-reference configuration from a network apparatus, wherein the LTM candidate configuration is not a complete configuration, wherein the complete configuration is a RRC message applied directly at a LTM cell switch. The UE determines whether the received LTM-reference configuration is set to setup or release for the at least one candidate cell of the plurality of candidate cells. When the received LTM-reference configuration is set to setup in the UE, the UE replaces or stores the received LTM-reference configuration. When the received LTM-Reference configuration is set to release, the UE deletes the LTM-reference configuration available in the UE.

Embodiments disclosed herein provide a method for handling the LTM in the wireless network. The method includes creating by the network apparatus, the LTM configuration comprising at least one LTM candidate configuration for at least one candidate cell of plurality of candidate cells to the UE. The network apparatus determines whether the at least one LTM candidate configuration is not a complete configuration, wherein in the complete configuration is a RRC message applied directly at the LTM cell switch. The network apparatus includes the LTM-reference configuration in the LTM configuration when at least one LTM candidate configuration is not a complete configuration. Further, the method includes transmitting, by the network apparatus, the LTM configuration for the at least one candidate cell of the plurality of candidate cells for which the LTM candidate configuration is not the complete LTM configuration to the UE, wherein the LTM configuration comprises the LTM-reference configuration.

Embodiments disclosed herein provide a UE for handling the LTM in the wireless network. The UE includes a memory, a processor, an I/O interface and a LTM controller coupled to the memory, the I/O interface and the processor. The LTM controller receives the LTM configuration comprising the LTM candidate configuration for at least one candidate cell of plurality of candidate cells, and an LTM-reference configuration from a network apparatus, wherein the LTM candidate configuration is not a complete configuration, wherein the complete configuration is the RRC message applied directly at the LTM cell switch. The LTM controller determines whether the received LTM-reference configuration is set to setup or release for the at least one candidate cell of the plurality of candidate cells. When the received LTM-Reference configuration is set to setup in the UE, the LTM controller replaces or stores the received LTM-reference configuration. When the received LTM-reference configuration is set to release, the LTM controller deletes the LTM-reference configuration available in the UE.

Embodiments disclosed herein provide a network apparatus for handling the LTM in the wireless network. The network apparatus includes a memory, a processor, an I/O interface and a LTM controller coupled to the memory, the I/O interface and the processor. The LTM controller creates the LTM configuration comprising at least one LTM candidate configuration for at least one candidate cell of plurality of candidate cells to the UE. The LTM controller determines whether the at least one LTM candidate configuration is not a complete configuration, wherein in the complete configuration is the RRC message applied directly at the LTM cell switch. The LTM controller includes the LTM-reference configuration in the LTM configuration when at least one LTM candidate configuration is not a complete configuration. Further, the LTM controller transmits the LTM configuration for the at least one candidate cell of the plurality of candidate cells for which the LTM candidate configuration is not the complete LTM configuration to the UE, wherein the LTM configuration comprises the LTM-reference configuration.

3GPP specifications TS38.300, TS38.331, TS 38.321 V17.4 are considered as relevant background for the present disclosure.

To avoid transmitting a large message over air interface, the network apparatus (gNB) can provide the LTM-candidate configuration as delta configuration (at least one of the LTM candidate cells are not having complete configuration) instead of full configuration. The network apparatus can indicate the UE to use source cell configuration as the reference for the delta configuration or provide the reference configuration explicitly.

In an embodiment, the network apparatus provides the LTM-candidate configuration, i.e. configure the LTM candidate cells through at least one of a RRC reconfiguration message for a candidate target cell, a CellGroupConfig for each candidate target cell, any similar RRC structure or a IE containing the similar fields (for e.g. a new IE LTM-CandidateConfig can be defined as ASN.1 sequence containing the CellGroupConfig and some other information elements in the RRCReconfiguration). The network apparatus may further release or modify the candidate configurations. The UE may store the LTM configuration of other candidate cells even after moving to the candidate cell through the LTM. The network apparatus also provides the UE with configuration for performing LTM measurements for different candidate frequencies and candidate cells, and reporting based on the performed LTM measurements.

The network apparatus provides the reference configuration, the L1 measurement configuration and the LTM candidate cell configuration in the RRC ASN.1 SEQUENCE used for LTM configuration. An example sequence is given as below.

```
ASN1START
-- TAG-RRCRECONFIGURATION-START
RRCReconfiguration ::= SEQUENCE {
  rrc-TransactionIdentifier RRC-TransactionIdentifier,
  criticalExtensions CHOICE {
    rrcReconfiguration RRCReconfiguration-Ies,
    criticalExtensionsFuture SEQUENCE { }
  }
}
RRCReconfiguration-Ies ::= SEQUENCE {
  radioBearerConfig RadioBearerConfig
OPTIONAL, -- Need M
  secondaryCellGroup OCTET STRING (CONTAINING
CellGroupConfig) OPTIONAL, -- Cond SCG
  measConfig MeasConfig
OPTIONAL, -- Need M
  lateNonCriticalExtension OCTET STRING
OPTIONAL,
  nonCriticalExtension RRCReconfiguration-v1530-Ies
OPTIONAL
}
RRCReconfiguration-v1530-Ies ::= SEQUENCE {
  masterCellGroup OCTET STRING (CONTAINING
CellGroupConfig) OPTIONAL, -- Need M
  fullConfig ENUMERATED {true}
OPTIONAL, -- Cond FullConfig
  dedicatedNAS-MessageList SEQUENCE (SIZE(1..maxDRB)) OF
DedicatedNAS-Message OPTIONAL, -- Cond nonHO
  masterKeyUpdate MasterKeyUpdate
OPTIONAL, -- Cond MasterKeyChange
  dedicatedSIB1-Delivery OCTET STRING (CONTAINING SIB1)
OPTIONAL, -- Need N
  dedicatedSystemInformationDelivery OCTET STRING (CONTAINING
SystemInformation) OPTIONAL, -- Need N
  otherConfig OtherConfig
OPTIONAL, -- Need M
  nonCriticalExtension RRCReconfiguration-v1540-Ies
OPTIONAL
}
RRCReconfiguration-v1540-Ies ::= SEQUENCE {
  otherConfig-v1540 OtherConfig-v1540
OPTIONAL, -- Need M
  nonCriticalExtension RRCReconfiguration-v1560-Ies
OPTIONAL
}
RRCReconfiguration-v1560-Ies ::= SEQUENCE {
  mrdc-SecondaryCellGroupConfig SetupRelease { MRDC-
SecondaryCellGroupConfig } OPTIONAL, -- Need M
  radioBearerConfig2 OCTET STRING (CONTAINING
RadioBearerConfig) OPTIONAL, -- Need M
  sk-Counter SK-Counter
OPTIONAL, -- Need N
nonCriticalExtension RRCReconfiguration-v1610-Ies
OPTIONAL
}
RRCReconfiguration-v1610-Ies ::= SEQUENCE {
  otherConfig-v1610 OtherConfig-v1610
OPTIONAL, -- Need M
  bap-Config-r16 SetupRelease { BAP-Config-r16 }
OPTIONAL, -- Need M
  iab-IP-AddressConfigurationList-r16 IAB-IP-AddressConfigurationList-
r16 OPTIONAL, -- Need M
  conditionalReconfiguration-r16 ConditionalReconfiguration-r16
OPTIONAL, -- Need M
  daps-SourceRelease-r16 ENUMERATED {true}
OPTIONAL, -- Need N
  t316-r16 SetupRelease {T316-r16}
OPTIONAL, -- Need M
  needForGapsConfigNR-r16 SetupRelease
{NeedForGapsConfigNR-r16} OPTIONAL, -- Need M
  onDemandSIB-Request-r16 SetupRelease { OnDemandSIB-
Request-r16 } OPTIONAL, -- Need M
  dedicatedPosSysInfoDelivery-r16 OCTET STRING (CONTAINING
PosSystemInformation-r16-Ies) OPTIONAL, -- Need N
  sl-ConfigDedicatedNR-r16 SetupRelease {SL-ConfigDedicatedNR-
r16} OPTIONAL,
  sl-ConfigDedicatedEUTRA-Info-r16 SetupRelease {SL-
ConfigDedicatedEUTRA-Info-r16} OPTIONAL, -- Need M
  targetCellSMTC-SCG-r16 SSB-MTC
OPTIONAL, -- Need S
  nonCriticalExtension RRCReconfiguration-v1700-Ies
OPTIONAL
}
RRCReconfiguration-v1700-Ies ::= SEQUENCE {
  otherConfig-v1700 OtherConfig-v1700
OPTIONAL, -- Need M
  sl-L2RelayUE-Config-r17 SetupRelease { SL-L2RelayUE-Config-
r17 } OPTIONAL, -- Need M
  sl-L2RemoteUE-Config-r17  SetupRelease { SL-L2RemoteUE-
Config-r17 }  OPTIONAL, -- Need M
  dedicatedPagingDelivery-r17  OCTET STRING (CONTAINING
Paging)  OPTIONAL, -- Cond PagingRelay
  needForGapNCSG-ConfigNR-r17 SetupRelease
{NeedForGapNCSG-ConfigNR-r17} OPTIONAL, -- Need M
  needForGapNCSG-ConfigEUTRA-r17 SetupRelease
{NeedForGapNCSG-ConfigEUTRA-r17}  OPTIONAL, -- Need M
  musim-GapConfig-r17 SetupRelease {MUSIM-GapConfig-r17}
OPTIONAL, -- Need M
  ul-GapFR2-Config-r17 SetupRelease { UL-GapFR2-Config-
r17 } OPTIONAL, -- Need M
  scg-State-r17 ENUMERATED { deactivated }
OPTIONAL, -- Need N
  appLayerMeasConfig-r17 AppLayerMeasConfig-r17
OPTIONAL, -- Need M
  ue-TxTEG-RequestUL-TDOA-Config-r17 SetupRelease {UE-TxTEG-
RequestUL-TDOA-Config-r17} OPTIONAL, -- Need M
  nonCriticalExtension RRCReconfiguration-v18xy
OPTIONAL
}
RRCReconfiguration-v18xy-Ies ::= SEQUENCE {
  ltm-CandidateConfig-r18 SetupRelease {LTM-CandidateConfig-
r18} OPTIONAL, -- Need M
  nonCriticalExtension SEQUENCE { }
OPTIONAL
}
```

### 6.3.2 Radio Resource Control Information Elements

### LTM-CandidateConfig

The IE LTM-CandidateConfig is used to provide the LTM candidate cell configuration.

When the UE receives RRC reconfiguration including the LTM candidate configuration, the UE performs the LTM configuration.

An example sequence for the LTM candidate configuration executed by the UE is given below (in the baseline CR for TS 38.331)

```
5.3.5.x LTM configuration and execution
5.3.5.x.1 General
The UE shall perform the following actions based on a received LTM-
CandidateConfig IE:
1> store the received ltmReferenceConfiguration in VarLTM-Config, if
present;
1> if the LTM-CandidateConfig includes the ltm-CandidateToReleaseList:
perform the LTM candidate cell release as specified in 5.3.5.x.2;
    2> perform the LTM candidate cell release as specified in 5.3.5.x.2;
1> if the LTM-CandidateConfig includes the ltmCandidateResetL2-List:
    2> add the received ltmCandidateResetL2-List to VarLTM-Config;
1> if the LTM-CandidateConfig includes the ltm-CandidateToAddModList:
    2> perform the LTM candidate cell addition or reconfiguration as
specified in 5.3.5.x.3;
1> perform the actions to generate a complete LTM configuration as specified in
5.3.5.x.4;
NOTE X: It is up to the UE implementation to postpone the generation of a
complete LTM configuration until the executing of an LTM cell switch.
5.3.5.x.2 LTM candidate cell release
The UE shall:
1> for each ltm-Candidateld in the ltmCandidateToReleaseList:
    2> if the current VarLTM-Config includes an ltmCandidate with the
given ltm-CandidateId:
        3> release the ltm-Candidate from VarLTM-Config;
5.3.5.x.3  LTM candidate cell addition/modification
The UE shall:
1> for each ltm-Candidateld in the ltm-CandidateToAddModList:
    2> if the current VarLTM-Config includes an ltmCandidate with the
given ltm-CandidateId:
        3> modify the ltmCandidate within VarLTM-Config in
accordance with the received ltmCandidate;
    2> else:
        3> add the received ltmCandidate to VarLTM-Config.
```

### 5.3.5.x.4 Generation of UE LTM Configuration

The purpose of this procedure is for the UE to generate a complete LTM candidate cell configuration to be stored and applied only when an indication of an LTM cell switch is received by lower layers. During the generation of a complete LTM candidate cell configuration, the current UE configuration shall not be modified.

The UE shall:

```
1> for each ltm-Candidate in ltmCandidateConfigList within VarLTM-Config;
    2> store the ltmCandidateId included in ltmCandidate within VarLTM-
UE-Config;
    2> if ltm-Candidate includes ltmConfigComplete;
        3> generate a complete LTM candidate cell configuration for the
received ltmCandidate according to the actions described in clause 5.3.5.3 and
store it in ue-LTM-Config within VarLTM-UE-Config.
    2> else:
        3> generate a complete LTM candidate cell configuration by
applying ltm-Candidate on top of referenceConfiguration according to the actions
described in clause 5.3.5.3 and store it in ue-LTM-Config within VarLTM-UE-
Config.
```

### 5.3.5.x.5 LTM Cell Switch Execution

Upon the indication by the lower layers that an LTM cell switch procedure is triggered, the UE shall:

```
1>  elease/clear all current dedicated radio configuration except for the
following:
      2> if the LTM cell switch is triggered on the Master Cell Group (MCG):
        - the MCG C-RNTI;
        - the AS security configurations associated with the master key;
      2> else, if the LTM cell switch is triggered on the Secondary Cell Group
(SCG):
        - the SCG C-RNTI;
        - the AS security configurations associated with the secondary key;
        - the SRB1/SRB2 configurations and DRB configurations as
            configured by radioBearerConfig or radioBearerConfig2;
        - the UE variables VarLTM-Config and VarLTM-UE-Config.
1> release/clear all current common radio configuration;
1> use the default values specified in 9.2.3 for timers T310, T311 and constants
N310, N311;
1> apply the default L1 parameter values as specified in corresponding
physical layer specifications except for the following:
- parameters for which values are provided in SIB1;
1> apply the value of the newUE-Identity as the C-RNTI for this cell group
according to the LTM candidate cell configuration related to the the LTM
candidate cell configuration identity as received by lower layers;
1> configure lower layers in accordance with the received
spCellConfigCommon according to the LTM candidate cell configuration
indicated by lower layers;
1> configure lower layers in accordance with the received rach-
ConfigDedicated according to the LTM candidate cell configuration indicated by
lower layers.
1> configure the PDCP entity for LTM candidate cell configuration indicated by
lower layers with state variables continuation as specified in TS 38.323 [5], and
with the same security configuration as the PDCP entity for the source cell group;
1> stop timer T310 for the corresponding SpCell, if running;
1> if this procedure is executed for the MCG:
      2> if timer T316 is running;
            3> stop timer T316;
1> stop timer T312 for the corresponding SpCell, if running;
1> apply the specified BCCH configuration defined in 9.1.1.1 for the target
LTM candidate cell configuration;
1> acquire the MIB of the target SpCell as indicated in the LTM candidate
cell configuration indicated by lower layers, which is scheduled as specified in
TS 38.213 [13], if applicable;
1> apply the LTM configuration in UE-LTM-Config within VarLTM-UE-Config
related to the LTM candidate cell configuration identity as received by lower
layers.
1> submit the RRCReconfigurationComplete message to lower layers for
transmission using the new configuration.
RRCReconfiguration-v1700-Ies ::= SEQUENCE {
  otherConfig-v1700 OtherConfig-v1700
OPTIONAL, -- Need M
  sl-L2RelayUE-Config-r17 SetupRelease { SL-L2RelayUE-Config-
r17 } OPTIONAL, -- Need M
  sl-L2RemoteUE-Config-r17 SetupRelease { SL-L2RemoteUE-
Config-r17 } OPTIONAL, -- Need M
  dedicatedPagingDelivery-r17 OCTET STRING (CONTAINING
Paging) OPTIONAL, -- Cond PagingRelay
  needForGapNCSG-ConfigNR-r17 SetupRelease
{NeedForGapNCSG-ConfigNR-r17} OPTIONAL, -- Need M
  needForGapNCSG-ConfigEUTRA-r17 SetupRelease
{NeedForGapNCSG-ConfigEUTRA-r17} OPTIONAL, -- Need M
  musim-GapConfig-r17 SetupRelease {MUSIM-GapConfig-r17}
OPTIONAL, -- Need M
  ul-GapFR2-Config-r17 SetupRelease { UL-GapFR2-Config-
r17 } OPTIONAL, -- Need M
  scg-State-r17 ENUMERATED { deactivated }
OPTIONAL, -- Need N
  appLayerMeasConfig-r17 AppLayerMeasConfig-r17
OPTIONAL, -- Need M
  ue-TxTEG-RequestUL-TDOA-Config-r17 SetupRelease {UE-TxTEG-
RequestUL-TDOA-Config-r17} OPTIONAL, -- Need M
  nonCriticalExtension RRCReconfiguration-v18xy
OPTIONAL
}
RRCReconfiguration-v18xy-Ies ::= SEQUENCE {
  ltmCandidateConfig-r18 SetupRelease {LTM-CandidateConfig-
r18} OPTIONAL, -- Need M
  nonCriticalExtension SEQUENCE { }
OPTIONAL
}
Ltm-CandidateConfig: Configuration of the LTM candidate cell(s), reference
configuration for LTM cell(s) and sets of cells in which full L2 reset is applied
upon an LTM cell switch.
-- Serving cell specific MAC and PHY parameters for a SpCell:
SpCellConfig ::=  SEQUENCE {
  servCellIndex  ServCellIndex
OPTIONAL, -- Cond SCG
  reconfiguration WithSync ReconfigurationWithSync
OPTIONAL, -- Cond ReconfWithSync
  rlf-TimersAndConstants SetupRelease { RLF-TimersAndConstants }
OPTIONAL, -- Need M
  rlmInSyncOutOfSyncThreshold ENUMERATED {n1}
OPTIONAL, -- Need S
  spCellConfigDedicated ServingCellConfig
OPTIONAL, -- Need M
  ...,
  [[
  lowMobilityEvaluationConnected-r17 SEQUENCE {
    s-SearchDeltaP-Connected-r17  ENUMERATED {dB3, dB6, dB9,
dB12, dB15, spare3, spare2, spare1},
    t-SearchDeltaP-Connected-r17  ENUMERATED {s5, s10, s20, s30,
s60, s120, s180, s240, s300, spare7, spare6, spare5,
                            spare4, spare3, spare2, spare1}
  } OPTIONAL, --
Need R
  goodServingCellEvaluationRLM-r17 GoodServingCellEvaluation-r17
OPTIONAL, -- Need R
  goodServingCellEvaluationBFD-r17 GoodServingCellEvaluation-r17
OPTIONAL, -- Need R
  deactivatedSCG-Config-r17 SetupRelease { DeactivatedSCG-Config-
r17 } OPTIONAL -- Cond SCG-Opt
  ]],
  ItmCellSwitchInfo SetupRelease { LtmCellSwitchInfo }
OPTIONAL  -- Need M
}
LtmCellSwitchInfo-r18 ::=  SEQUENCE {
  spCellConfigCommon  ServingCellConfigCommon
OPTIONAL,  -- Need M
  newUE-Identity  RNTI-Value,
  rach-ConfigDedicated CHOICE {
    uplink RACH-ConfigDedicated,
    supplementaryUplink RACH-ConfigDedicated
  } OPTIONAL, --
Need N
}
ItmCellSwitchInfo: This field contains necessary information for the UE to
execute an LTM cell switch procedure in case this cell is a LTM target cell.
LTM-CandidateConfig: The IE LTM-CandidateConfig is used to provide LTM
candidate cell configuration.
LTM-CandidateConfig information element
-- ASNISTART
-- TAG-LTM-CANDIDATECONFIG-START
LTM-CandidateConfig-r18 ::= SEQUENCE {
  lte-ReferenceConfiguration-r18 OCTET STRING (CONTAINING
RRCReconfiguration), OPTIONAL, -- Cond FirstLTM-
Candidate
  ltmCandidateToReleaseList-r18 LTM-CandidateToReleaseList-r18
OPTIONAL, -- Need N
  ltm-CandidateToAddModList-r18 LTM-CandidateToAddModList-r18
OPTIONAL, -- Need N
  ltm-CandidateResetL2-List-r18 SetupRelease { LTM-
CandidateResetL2-List-r18 } OPTIONAL -- Need M
  ...
LTM-CandidateToReleaseList-r18 ::= SEQUENCE (SIZE
(1..maxNrofCellsLTM-r18)) OF LTM-CandidateId-r18 OPTIONAL --
Need N
LTM-CandidateToAddModList-r18 ::= SEQUENCE (SIZE
(1..maxNrofCellsLTM-r18)) OF LTM-Candidate-r18
LTM-Candidate-r18 ::= SEQUENCE {
  ltmCandidateId-r18 LTM-CandidateId-r18,
  ltmConfig-r18 OCTET STRING (CONTAINING
RRCReconfiguration),
  ltm-ConfigComplete-r18 ENUMERATED {true}
OPTIONAL -- Need R
  ...
}
LTM-CandidateResetL2-List-r18 :: = SEQUENCE (SIZE
(1..maxNrofCellsLTM-r18)) OF LTM-CandidateId-r18
Editor's Note: FFS on whether the LTM-CandidateNoResetL2-List field should
include separate reset flags for MAC, RLC, and PDCP recovery.
-- TAG-LTM-CANDIDATECONFIG-STOP
--ASNISTOP
```

LTM-CandidateConfig field descriptions

ltm-Config
This field includes an RRCReconfiguration message used to configure
an LTM candidate cell. This field shall include the
CellGroupConfig IE, and it may also include the
RadioBearerConfig IE, and MeasConfig IE.
ltm-ConfigComplete
This field indicates whether the LTM candidate cell configuration
within ltm-Config is a complete configuration and thus
the UE shall not use the LTM reference configuration
within the field lte-ReferenceConfiguration.
ltm-CandidateNoResetL2-List
This field includes a list of LTM candidate cell
identifiers for which the full L2 reset is needed
upon an LTM cell switch.
ltm-ReferenceConfiguration
This field includes an RRCReconfiguration message
used to configure a reference configuration for LTM.

| Conditional | |
|---|---|
| Presence | Explanation |
| FirstLTM- | This field is mandatory present upon the first |
| Candidate | configuration of LTM-CandidateConfig. Otherwise, |
| | the field is optionally present, Need M. |

### 7.4 UE Variables:

VarLTM-Config: The IE VarLTM-Config is used to store the reference configuration and the LTM candidate cell configurations.

```
VarLTM-Config UE variable
-- ASNISTART
-- TAG-VARLTM-CONFIG-START
VarLTM-Config-r18-IEs ::= SEQUENCE {
  ltmReferenceConfiguration-r18 OCTET STRING (CONTAINING
RRCReconfiguration),
  ltmCandidateList-r18 LTM-CandidateList-r18
  ltmCandidateResetL2-List-r18 LTM-CandidateResetL2-List-r18
}
LTM-CandidateList-r18 ::= SEQUENCE (SIZE (1..maxNrofCellsLTM-r18))
OF LTM-Candidate-r18
LTM-CandidateResetL2-List-r18 ::= SEQUENCE (SIZE
(1..maxNrofCellsLTM-r18)) OF LTM-Candidate-r18
-- TAG-VARLTM-CONFIG-STOP
-- ASNISTOP
VarLTM-UE-Config: The IE VarLTM-UE-Config is used to store the generated
UE configuration related to the received LTM candidate cell configurations.
VarLTM-UE-Config UE variable
-- ASNISTART
-- TAG-VARLTM-CONFIG-START
VarLTM-UE-Config-r18-IEs ::= SEQUENCE {
  Ue-ltmConfigCandidateList-r18 UE-LTM-ConfigCandidateList-r18
}
UE-LTM-ConfigCandidateList-r18 ::= SEQUENCE (SIZE
(1..maxNrofCellsLTM-r18)) OF UE-LTM-Config-r18
UE-LTM-Candidate-r18 ::= SEQUENCE {
  ltmCandidateId-r18 LTM-CandidateId-r18,
  ue-LTM-Config-r18 OCTET STRING,
}
-- TAG-VARLTM-CONFIG-STOP
-- ASNISTOP
```

Dual connectivity or more technically Multi-Radio Dual Connectivity (MR-DC) is specified by the 3GPP in specifications TS 37.340. Next Generation-Radio Access Network (NG-RAN) supports the MR-DC operation whereby the UE in the RRC_CONNECTED is configured to utilize radio resources provided by two distinct schedulers, located in two different NG-RAN nodes connected via a non-ideal backhaul, one providing NR access and the other one providing either Evolved UMTS Terrestrial Radio Access (E-UTRA) or NR access. One node acts as Master Node (MN) and the other as Secondary Node (SN). The MN and SN are connected via a network interface and at least the MN is connected to the core network. The NG-RAN supports NG-RAN E-UTRA-NR Dual Connectivity (NGEN-DC), in which a UE is connected to one NG-eNB (a E-UTRA base station that can connect to 5G core) that acts as a MN and one Gnb (5G base station) that acts as a SN. The NG-RAN also supports NR-E-UTRA Dual Connectivity (NE-DC), in which a UE is connected to one gNB that acts as a MN and one ng-eNB that acts as a SN.

In an embodiment, the UE sends MCGFailureInformation to report MCG failures to SCG, i.e. the MCG radio link failure. A fast MCG link recovery procedure may be performed by the network after receiving the MCGFailureInformation. The Network sends MCG reconfiguration message through the SCG to recover the MCG. The UE starts a timer known as T316 timer after initiating the MCGFailureInformation. When the UE does not receive the MCG reconfiguration before the expiry of the timer, the UE will initiate RRC reestablishment procedure. Fast MCG link recovery is detailed in 3gpp specifications like TS 38.331.

The proposed solution provides methods for configuring and performing the LTM. The methods include embodiments for both the UE and the network apparatus. The method includes handling the LTM reference configuration modification and release at the UE. The network indicates modification or release of the LTM reference configuration stored at the UE for candidate cells for which a LTM candidate configuration is not a complete LTM configuration. The LTM reference configuration is included in the LTM candidate configuration. Further the proposed solution includes determining whether the at least one LTM candidate configuration is not a complete configuration based on a LTM configuration complete message received from the UE. The network apparatus transmits the LTM candidate configuration for which the LTM candidate configuration is not the complete LTM configuration. Further the solution includes configuring interruptions for LTM measurements, wherein the UE indicates to the network whether interruption is needed for performing the LTM measurements for both inter frequency and intra-frequency LTM measurements without a gap.

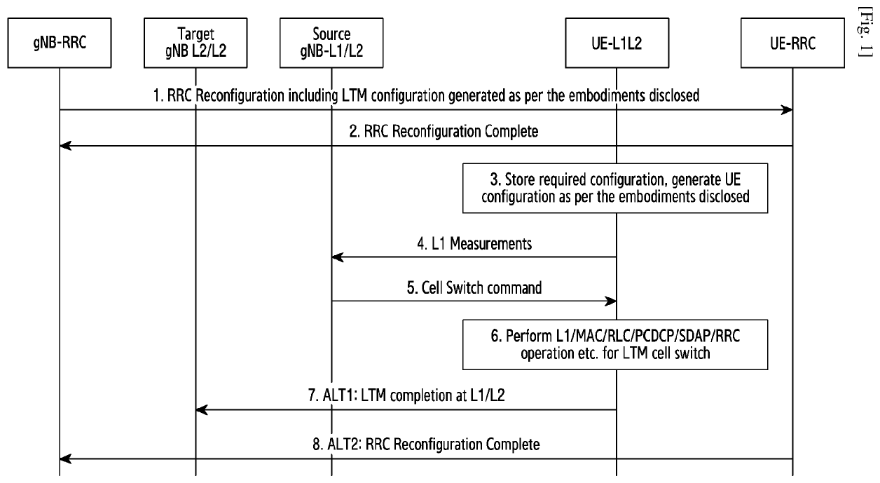

Referring now to the drawings and more particularly to FIGS. 1 through 7, where similar reference characters denote corresponding features consistently throughout the figure, these are shown preferred embodiments.

FIG. 1 is a sequence diagram that illustrates overall flow of the LTM in the wireless network, accordingly to embodiments as disclosed herein. The LTM is a procedure in which the gNB or network apparatus receives the L1 measurement report(s) from the UE, and based on the received L1 measurement report(s) from the UE, the gNB changes UE serving cell by a cell switch command signaled via a MAC CE. The cell switch command indicates an LTM candidate configuration that the gNB previously prepared and provided to the UE through the RRC signaling. Then the UE switches to the target configuration according to the cell switch command. The LTM procedure can be used to reduce the mobility latency and signaling overhead.

In an embodiment, when configured by the network, it is possible to activate Transmission Configuration Indicator (TCI) states of one or multiple cells that are different from the current serving cell. For instance, the TCI states of the LTM candidate cells can be activated in advance before any of those cells become the serving cell. This allows the UE to be Downlink (DL) synchronized with those cells, thereby facilitating a faster cell switch to one of those cells when cell switch is triggered.

When configured by the network, it is possible to initiate Uplink (UL) Timing Advance (TA) acquisition (called early TA) procedure of one or multiple cells that are different from the current serving cells. When the cell has the same NTA as the current serving cells or NTA=0, early TA acquisition procedure is not required. The network may request the UE to perform early TA acquisition of a candidate cell before a cell switch. The early TA acquisition procedure is triggered by Physical Downlink Control Channel (PDCCH) order or realized through UE-based TA measurement as configured by the RRC. In the former case, the gNB to which the candidate cell belongs calculates the TA value and sends it to the gNB to which the serving cell belongs. The serving cell sends the TA value in the LTM cell switch command MAC CE when triggering LTM cell switch. In the latter case, the UE performs TA measurement for the candidate cells after being configured by RRC but the exact time the UE performs TA measurement is up to UE implementation. The UE applies the TA value measured by itself and performs Random Access Channel (RACH)-less LTM upon receiving the cell switch command. The network may also send a TA value in the LTM cell switch command MAC CE without early TA acquisition.

Depending on the availability of a valid TA value, the UE performs either a RACH-less LTM or RACH-based LTM cell switch. When the TA value is provided in the cell switch command, the UE applies the TA value as instructed by the network. In the case where UE-based TA measurement is configured, but no TA value is provided in the cell switch command, the UE applies the TA value by itself if available. Meanwhile, the UE performs RACH-less LTM cell switch upon receiving the cell switch command. If no valid TA value is available, the UE performs RACH-based LTM cell switch.

Regardless of whether the UE is configured for UE-based TA measurement for a certain candidate cell, it will still follow the PDCCH order, which includes requesting a random access procedure towards the candidate cells. This also applies to the candidate cells for which the UE is capable of deriving TA values by itself. Additionally, regardless of whether the UE has already performed a random access procedure towards the candidate cells, it will still follow the UE-based measurement configuration if configured by the network.

For RACH-less LTM, the UE accesses the target cell using either a configured grant or a dynamic grant. The configured grant is provided in the LTM candidate configuration, and the UE selects the configured grant occasion associated with the beam indicated in the cell switch command. Upon initiation of LTM cell switch to the target cell, the UE starts to monitor PDCCH on the target cell for dynamic scheduling. Before RACH-less LTM procedure completion, the UE shall not trigger random access procedure when the UE does not have a valid Physical Uplink Control Channel (PUCCH) resource for triggered Scheduling Requests (SRs).

The following principles apply to LTM:
Security key is maintained upon an LTM cell switch;
Subsequent LTM is supported.

The LTM supports both intra-gNB-DU and intra-gNB-CU inter-gNB-DU mobility. LTM supports both intra-frequency and inter-frequency mobility, including mobility to inter-frequency cell that is not a current serving cell. The LTM is supported only for licensed spectrum. The following scenarios are supported:
PCell change in non-CA scenario and non-DC scenario;
PCell and SCell(s) change in CA scenario;
Dual connectivity scenario, PCell and MCG SCell(s) change and intra-SN PSCell and SCG SCell(s) change without MN involvement. LTM for simultaneous PCell and PSCell change is not supported.

While the UE has stored LTM candidate configurations the UE can also execute any L3 handover command sent by the network.

Cell switch command is conveyed in the MAC CE, which contains the necessary information to perform the LTM cell switch.

The overall procedure for LTM is shown in the FIG. 1. Subsequent LTM is done by repeating the early synchronization, LTM cell switch execution, and LTM cell switch completion steps without releasing other LTM candidate configurations after each LTM cell switch completion. The general procedure over the air interface is applicable to SCG LTM. At step 1, the gNB transmits the RRC reconfiguration message to the UE including the configuration of one or multiple LTM candidate target cells as per the technical aspects disclosed in the present disclosure.

At step 2, the UE transmits RRC reconfiguration complete message to the gNB indicating RRC reconfiguration complete.

At step 3, the UE stores the configuration of LTM candidate target cell(s) and generates UE configurations for each candidate target cells. In an embodiment, the UE may perform DL synchronization and TA acquisition with candidate target cell(s) before receiving the LTM cell switch command.

At step 4, the UE performs L1 measurements on the configured LTM candidate target cell(s), and transmits lower-layer measurement reports to the gNB.

At step 5, the source gNB decides to execute the LTM cell switch to a target cell, and transmits the MAC-CE triggering the LTM cell switch. The UE switches to the configuration of the LTM candidate target cell.

At step 6, the UE switches to the configuration of the LTM candidate target cell by performing L1/MAC/RLC/PCDCP/SDAP/RRC operation etc.

At step 7, optionally the UE in target cell sends a LTM completion message to the target gNB.

At step 8, optionally the UE transmits RRC reconfiguration complete message to the gNB indicating RRC reconfiguration complete.

FIG. 2 is a block diagram of a UE (201) for handling the LTM in the wireless network, accordingly to embodiments as disclosed herein. With reference to FIG. 2, the UE (201) can encompass a diverse range of devices, including but not limited to laptops, palmtops, desktops, mobile phones, smart phones, Personal Digital Assistants (PDAs), tablets, wearable devices, Internet of Things (IoT) devices, virtual reality devices, foldable devices, flexible devices, display devices, and immersive systems. In an embodiment, the UE (201) includes a memory (205), a communication processor (203), an Input/Output (I/O) interface (204), and a LTM controller (206).

The memory (205) is configured to store instructions to be executed by the communication processor (203). The memory (205) can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (205) may, in some examples, be considered a non-transitory storage medium. The term “non-transitory” may indicate that the storage medium is not embodied in a carrier wave or a propagated signal. However, the term “non-transitory” should not be interpreted that the memory (205) is non-movable. In some examples, the memory (205) is configured to store larger amounts of information. In certain examples, a non-transitory storage medium may store data that can, over time, change (e.g., in Random Access Memory (RAM) or cache).

The communication processor (203) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The communication processor (203) may include multiple cores and is configured to execute the instructions stored in the memory (205).

The I/O interface (204) transmits the information between the memory (205) and external peripheral devices. The peripheral devices are the input-output devices associated with a network apparatus (202). The I/O interface (204) receives several information from plurality of UEs, network devices, server and the like.

In an embodiment, the LTM controller (206) of the UE (201) communicates with the processor (203), I/O interface (204) and memory (205) for handling the LTM in the wireless network. The LTM controller (206) receives the LTM configuration comprising the LTM candidate configuration for at least one candidate cell of plurality of candidate cells, and an LTM-reference configuration from a network apparatus, wherein the LTM candidate configuration is not a complete configuration, wherein the complete configuration is the RRC message applied directly at the LTM cell switch. The LTM controller (206) determines whether the received LTM-reference configuration is set to setup or release for the at least one candidate cell of the plurality of candidate cells. When the received LTM-Reference configuration is set to setup in the UE (201), the LTM controller (206) replaces or stores the received LTM-reference configuration. When the received LTM-reference configuration is set to release, the LTM controller (206) deletes the LTM-reference configuration available in the UE (201).

In an embodiment, the LTM controller (206) determines whether the UE configuration comprises the LTM-reference configuration, wherein the single LTM reference configuration is applicable for all the non-complete candidate cell configurations. When the UE configuration comprises the LTM-reference configuration, the LTM controller (206) replaces the LTM-reference configuration in the UE configuration with the received LTM-reference configuration, and regenerates and stores a RRC reconfiguration message for the at least one candidate cell of the plurality of candidate cells by applying the LTM candidate configuration and the LTM reference configuration, wherein the RRC reconfiguration message is applied at the time of LTM cell switch to the candidate cell. When the UE configuration does not comprise the LTM-reference configuration, the LTM controller (206) stores the received LTM-reference configuration in the UE (201) for the at least one candidate cell of the plurality of candidate cells, and generates and stores the RRC reconfiguration message for the at least one candidate cell of the plurality of candidate cells by applying the LTM candidate configuration and the LTM reference configuration.

The LTM controller (206) is an inventive hardware component that is incorporated into the UE (201) through processing circuitry, comprising of logic gates, integrated circuits, microprocessors, microcontrollers, memory circuits, passive and active electronic components, optical components, hardwired circuits, or similar technologies. These circuits can be manifested in one or more semiconductor chips or on substrate supports such as printed circuit boards.

At least one of the plurality of components of the LTM controller (206) may be implemented through an AI model. A function associated with the AI model may be performed through the memory (205) and the processor (203). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

The AI model may consist of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

Whilst FIG. 2 depicts the hardware components of the UE (201), it should be noted that alternative embodiments are not confined to these elements. The UE (201) may comprise a greater or lesser number of hardware components in other embodiments. Additionally, the labels or names assigned to these elements are purely for illustrative purposes and do not restrict the scope of the invention. Furthermore, it is possible for one or more components to be merged together to perform the same or a substantially similar function.

In an embodiment, upon receiving the RRC reconfiguration message such as NR RRC reconfiguration from the network apparatus (gNB) which releases the LTM reference configuration for the LTM, the UE (201) releases the generated UE configuration related to the received LTM candidate cell configurations. The UE (201) deletes the LTM reference configuration from the variable LTM configuration (UE variable which is used for storing the LTM reference configuration such as VarLTM-Config) for the corresponding candidate cell or all the candidate cells which is specified by the network apparatus.

In an embodiment, upon receiving the RRC reconfiguration message such as the NR RRC reconfiguration which releases the LTM reference configuration for the LTM, the UE (201) releases the generated UE configuration related to the received LTM candidate cell configurations which are not complete configurations or incomplete configurations (or which are delta configurations). The UE (201) deletes the LTM reference configuration from the variable LTM configuration (UE variable which is used for storing the LTM reference configuration) for the corresponding candidate cell or for all the candidate cells which is specified by the network apparatus.

In an embodiment, the incomplete LTM candidate cell configurations refer to candidate cells for which the network apparatus has not yet received the complete LTM configuration message from the UE (201).

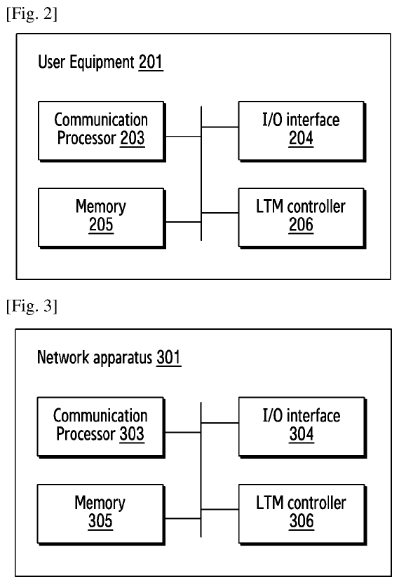

FIG. 3 is a block diagram of a network apparatus (301) for handling the LTM in the wireless network, accordingly to embodiments as disclosed herein;

The network apparatus (301) includes a processor (303), a memory (305), an I/O interface (304) and a LTM controller (306). The network apparatus (301) communicates with the UE (201) for handling the LTM in the wireless network. For example, the network apparatus (301) can include, but not limited to a base station access point, a central server, or similar equipment. Further, the processor (303) of the network apparatus (301) communicates with the memory (305), the I/O interface (304) and the LTM controller (306). The processor (303) is configured to execute instructions stored in the memory (305) and to perform various processes. The processor (303) can include one or a plurality of processors, can be a general-purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU).

Further, the memory (305) of the network apparatus (301) includes storage locations to be addressable through the processor (303). The memory (305) is but not limited to a volatile memory and/or a non-volatile memory. Further, the memory (305) can include one or more computer-readable storage media. The memory (305) can include non-volatile storage elements. For example, non-volatile storage elements can include magnetic hard discs, optical discs, floppy discs, flash memories, or forms of EPROM or EEPROM memories. The memory (303) can store the media streams such as audios stream, video streams, haptic feedbacks and the like. Also, the memory (305) of the network apparatus (301) can store several information received from the UE (201). For example, the memory (305) can store several information such as the LTM candidate configuration, delta configurations, LTM reference configurations, LTM complete configurations and the like for the at least one candidate cell of the plurality of the candidate cells associated with the network apparatus (301) in the wireless network.

The I/O interface (213) transmits the information between the memory (305) and external peripheral devices. The peripheral devices are the input-output devices associated with the network apparatus (301). The I/O interface (304) receives several information from the network apparatus (301). The several information received from the UE (201) can include but not limited to the LTM candidate configuration, delta configurations, LTM reference configurations, LTM complete configurations.

The LTM controller (306) communicates with the I/O interface (304) and memory (305) for handling the LTM in the wireless network. The LTM controller (306) is an innovative hardware that is realized through the physical implementation of both analog and digital circuits, including logic gates, integrated circuits, microprocessors, microcontrollers, memory circuits, passive and active electronic components, as well as optical components. The LTM controller (306) of the network apparatus (301) transmits a signaling message to the UE (201) wherein the signaling message comprises the at least one of the LTM candidate configuration, delta configurations, LTM reference configurations, LTM complete configurations.

In an embodiment, the LTM controller (306) creates the LTM configuration comprising at least one LTM candidate configuration for at least one candidate cell of plurality of candidate cells to the UE (201). The LTM controller (306) determines whether the at least one LTM candidate configuration is not a complete configuration, wherein in the complete configuration is the RRC message applied directly at the LTM cell switch. The LTM controller (306) includes the LTM-reference configuration in the LTM configuration when at least one LTM candidate configuration is not a complete configuration. Further, the LTM controller transmits the LTM configuration for the at least one candidate cell of the plurality of candidate cells for which the LTM candidate configuration is not the complete LTM configuration to the UE (201), wherein the LTM configuration comprises the LTM-reference configuration.

In an embodiment, the LTM controller (306) releases the LTM candidate configuration upon releasing the LTM-reference configuration, wherein the LTM candidate configuration is not a complete configuration.

In an embodiment, the LTM controller (306) configures the UE (201) to maintain the LTM-reference configuration when the at least one LTM candidate configuration is configured in the UE, wherein the at least one LTM candidate configuration is not a complete configuration.

At least one of the plurality of components of the LTM controller (306) may be implemented through an AI model. A function associated with the AI model may be performed through the memory (305) and the processor (303). The one or a plurality of processors controls the processing of the input data in accordance with a predefined operating rule or the AI model stored in the non-volatile memory and the volatile memory. The predefined operating rule or artificial intelligence model is provided through training or learning.

Here, being provided through learning means that, by applying a learning process to a plurality of learning data, a predefined operating rule or AI model of a desired characteristic is made. The learning may be performed in a device itself in which AI according to an embodiment is performed, and/or may be implemented through a separate server/system.

Whilst FIG. 3 depicts the hardware components of the network apparatus (301), it should be noted that alternative embodiments are not confined to these elements. The network apparatus (301) may comprise a greater or lesser number of hardware components in other embodiments. Additionally, the labels or names assigned to these elements are purely for illustrative purposes and do not restrict the scope of the invention. Furthermore, it is possible for one or more components to be merged together to perform the same or a substantially similar function.

In an embodiment, while sending the RRC reconfiguration message such as the NR RRC reconfiguration which releases the LTM-reference configuration for the LTM, the network apparatus (301) releases all the candidate cells (as configured using LTM-Candidate-r18) which are not having complete configuration (for e.g. complete configuration may be provided when ltm-ConfigComplete in the LTM-Candidate is set and is true).

In an embodiment, the network apparatus (301) such as the gNB in the NR which implements the LTM, upon adding the LTM candidate cells for the first time for the UE (201) (i.e. while adding LTM candidate cells when no other LTM candidate cells are configured) where in at least one of the LTM candidate cells are configured with delta configuration i.e. at least one of the LTM candidate cells are not having complete configuration, the network apparatus (301) sends the LTM reference configuration (ltm-ReferenceConfiguration) to the UE (201). In an embodiment, the LTM reference configuration is included in the LTM candidate configuration.

In an embodiment, the network apparatus (301) such as the gNB in the NR which implements the LTM, upon adding LTM candidate cells for the first time for the UE (201) (i.e. while adding LTM candidate cells when no other LTM candidate cells are configured) where in at least all the LTM candidate cells are configured with the complete configuration, the network apparatus (301) avoids sending the LTM reference configuration (ltm-ReferenceConfiguration) to the UE (201).

In an embodiment, the network apparatus (301) such as the gNB in the NR which implements the LTM, upon adding LTM candidate cells which do not have complete configuration for the first time for the UE (201) (such as while adding the LTM candidate cells when either no other LTM candidate cells are configured or all the configured candidate cells are having complete configuration), the network apparatus (301) includes the LTM reference configuration (ltm-ReferenceConfiguration) to the UE (201).

In an embodiment, the scenario of adding the LTM candidate cells for the first time for the UE (201) (i.e. adding the LTM candidate cells when no other LTM candidate cells are configured) may be captured in RRC specification TS 38.331 as below:

| Conditional | |
|---|---|
| Presence | Explanation |
| FirstLTM- | This field is mandatory present upon the first |
| Candidate | configuration of LTM-CandidateConfig where there is |
| | at least one candidate with cellltm-ConfigComplete- |
| | r18 is not true. Otherwise, the field is optionally |
| | present, Need M. |

In an embodiment, the NR UE (201) which has started a NR RRC timer NR RRC T316, i.e. which has sent a message such as NR MCGFailureInformation message to the network apparatus (301) while the LTM measurements (such as L1 measurements for one or more candidate cells for the LTM) are configured skips reporting the LTM measurements to the network apparatus (301) (e.g. gNB DU). In an embodiment the LTM measurements not reported are only for MCG in the above scenarios. In an embodiment, the LTM measurements not reported are for both MCG and SCG in the above scenarios.

In an embodiment, the UE (201) may still continue to perform the LTM measurements for the MCG when the T316 is running. In an embodiment, the UE (201) may still continue to perform the LTM measurements for the MCG and the SCG when the T316 is running.

In an embodiment, the UE (201) may pause or stop performing the LTM measurements for the MCG while the T316 is running. In an embodiment, the UE (201) may pause or stop performing the LTM measurements for the MCG and SCG while the T316 is running.

In an embodiment, the NR UE (201) which has sent SCGFailureInformation while the LTM measurements (such as the L1 measurements for one or more candidate cells for the LTM) are configured, the UE (201) stops reporting the LTM measurements to the network apparatus (301) (e.g. gNB DU). In an embodiment, the LTM measurements stopped are SCG measurements. In an embodiment, the UE (201) may still continue to perform the LTM measurements for the SCG. Alternatively, the UE (201) may stop performing the LTM measurements for the SCG while sending the SCGFailureInformation.

In an embodiment, the UE (201) which performs full configuration for the LTM, releases the generated UE configuration related to the received LTM candidate cell configurations.

In an alternative embodiment, the UE (201) which performs the full configuration for the LTM, keeps the generated UE configuration related to the received LTM candidate cell configurations. In an alternative embodiment, the UE (201) which performs the full configuration for the LTM, keeps the generated UE configuration related to the received LTM candidate cell configurations, which are complete configuration while releasing the LTM candidate cell configurations which are delta configurations.

In an embodiment, the UE (201) which has received the LTM measurement configuration, stores the received LTM measurement configuration in the UE variable which is used for storing the LTM reference configuration (such as VarLTM-Config.)

In an embodiment, the UE (201) which has received the LTM measurement configuration stores the received LTM measurement configuration in the UE variable which is used for storing the LTM candidate cell configuration (such as VarLTM-Config.)

This may lead to following changes in the RRC specification TS 38.331:

5.3.5.x.1 General

The UE (201) shall perform the following actions based on a received LTM-
CandidateConfig IE:
1> store the received LTM measurement configuration in the VarLTM-
Config, if present;
1> configure lower layers in accordance to the received LTM measurement
configuration.

In an embodiment, the UE (201) indicates to the network apparatus (301) whether interruption is needed for performing the LTM measurements for both inter frequency and intra-frequency LTM measurements without gap.

In an embodiment, the UE (201) reports whether interruption is needed for performing the LTM measurements for both the inter frequency and intra-frequency LTM measurements without gap, per band for inter frequency or per serving cell for intra frequency.

This may be captured in NR RRC specification as below:

```
NeedForLTMNCSG-IntraFreq-r18 ::= SEQUENCE {
  servCellId-r18 ServCellIndex,
  gapIndicationIntra-r18 ENUMERATED {gap, ncsg, no-gap-with-
interruption, no-gap-no-interruption}
}
NeedForLTMNCSG-NR-r18 ::= SEQUENCE {
bandNR-r18 FreqBandIndicatorNR,
gapIndication-r18 ENUMERATED {gap, ncsg, no-gap-with-
interruption, no-gap-no-interruption}
}
Alternatively it could be as below:
NeedForGapsLTMIntraFreq-r18 ::= SEQUENCE {
servCellId-r18 ServCellIndex,
gapIndicationIntra-r18 ENUMERATED {gap, no-gap-with-
interruption, no-gap-no-interruption}
}
NeedForGapsLTMNR-r18 ::= SEQUENCE {
  bandNR-r18 FreqBandIndicatorNR,
  gapIndication-r18 ENUMERATED {gap, no-gap-with-interruption,
no-gap-no-interruption}
}
Another Alternative could be as below:
NeedForLTMInterruptionInfoNR-r18 ::=  SEQUENCE {
  intraFreq-needForInterruption-r18 SEQUENCE(SIZE (1..
maxNrofServingCells)) OF NeedForInterruptionNR-r18,
  interFreq-needForInterruption-r18 SEQUENCE(SIZE (1..maxBands)) OF
NeedForInterruptionNR-r18
}
NeedForLTMInterruptionNR-r18 ::= SEQUENCE {
  intrIndication-r18 ENUMERATED {no-gap-with-interruption, no-gap-no-
interruption} OPTIONAL
}
```

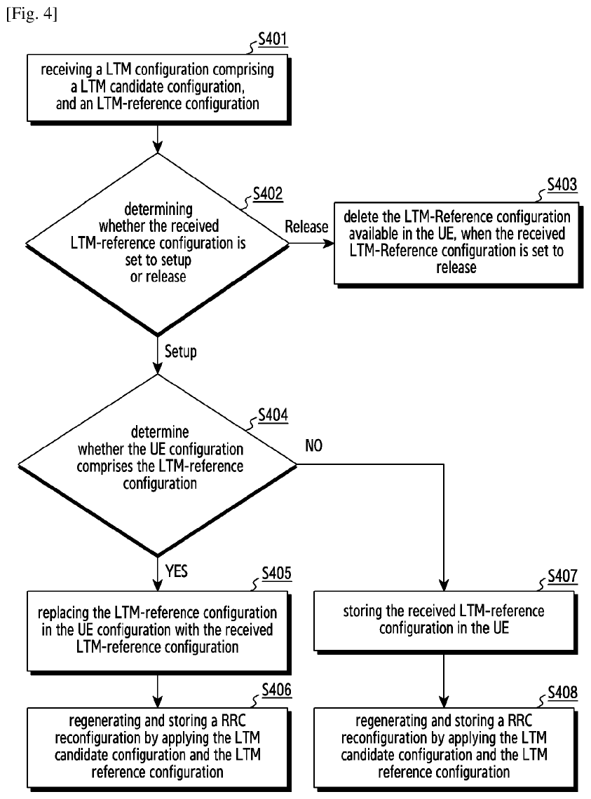

FIG. 4 is a flow diagram illustrating the UE (201) handling the LTM in the wireless network, accordingly to the embodiments as disclosed herein. At step S401, the UE (201) receives the LTM configuration comprising the LTM candidate configuration for at least one candidate cell of plurality of candidate cells from the network apparatus (301). The LTM candidate configuration includes the LTM-reference configuration, wherein the LTM candidate configuration is not a complete configuration, wherein the complete configuration is the RRC message applied directly at the LTM cell switch.

At step S402, the UE (201) determines whether the received LTM-reference configuration is set to setup or release for the at least one candidate cell of the plurality of candidate cells. The network apparatus (301) may release or modify the LTM reference configuration based on the delta configuration and the incomplete configurations.

At step S403, when the LTM reference configuration is set to release, the UE (201) deletes the LTM-reference configuration available at the UE (201). Further, the UE (201) deletes the RRC reconfiguration message generated by applying the LTM reference configuration.

At step S404, the UE (201) determines whether the UE configuration comprises the LTM-reference configuration, wherein the single LTM reference configuration is applicable for all the non-complete candidate cell configurations.

At step S405, when the UE configuration comprises the LTM reference configuration at the UE (201), the UE (201) replaces the LTM-reference configuration in the UE configuration with the received LTM-reference configuration for the at least one candidate cell of the plurality of candidate cells.

At step S406, the UE (201) regenerates the RRC reconfiguration message for the at least one candidate cell of the plurality of candidate cells by applying the LTM candidate configuration and the LTM reference configuration after replacing the LTM-reference configuration in the UE configuration with the received LTM-reference configuration, wherein the RRC reconfiguration message is applied at the time of the LTM cell switch to the candidate cell. Further the UE (201) stores the regenerated UE configuration at the UE variable.

At step S407, when the UE (201) does not include the received LTM reference configuration, the UE (201) stores the received LTM reference configuration.

At step S408, based on the stored LTM reference configuration, the UE (201) regenerates the RRC reconfiguration message for the at least one candidate cell of the plurality of candidate cells by applying the LTM candidate configuration and the LTM reference configuration after storing the received LTM-reference configuration in the UE configuration.

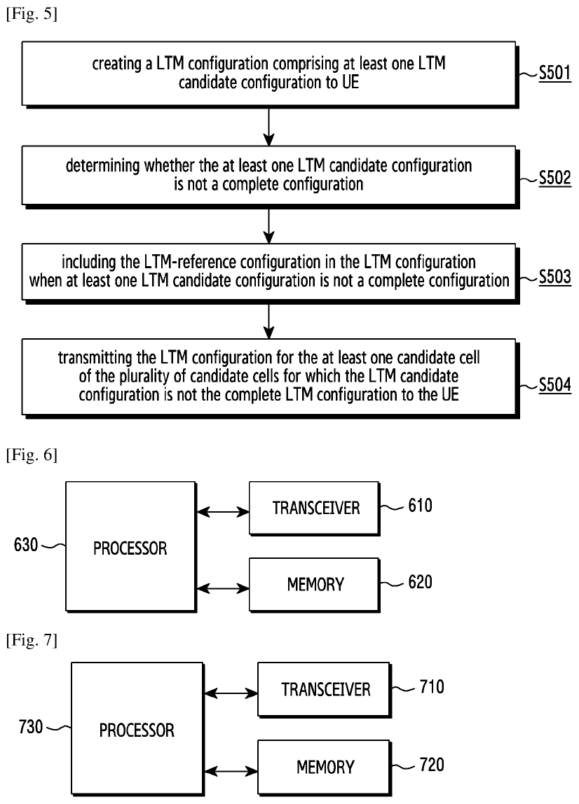

FIG. 5 is a flow diagram illustrating the network apparatus (301) handling the LTM in the wireless network, accordingly to the embodiments as disclosed herein. At step S501, the network apparatus creates the LTM configuration comprising at least one LTM candidate configuration for at least one candidate cell of plurality of candidate cells to the UE (201).

At step S502, the network apparatus (301) determines whether the at least one LTM candidate configuration is not a complete configuration, wherein in the complete configuration is a RRC message applied directly at the LTM cell switch. A complete LTM configuration is a RRC message which includes all the parameters the UE (201) needs to operate in the wireless network after the LTM cell switch to a target LTM cell. i.e. it includes configurations for various layers such as layer1, layer2, layer3, configuration of radio bearers, measurement configurations and so on. During the LTM cell switch, the UE (201) can directly use this configuration. If the LTM configuration is not a complete configuration, it includes only a part of the above configurations.

At step S503, the network apparatus (301) includes the LTM-reference configuration in the LTM configuration when at least one LTM candidate configuration is not a complete configuration.

At step S504, the network apparatus (301) sends the LTM configuration for the at least one candidate cell of the plurality of candidate cells for which the LTM candidate configuration is not the complete LTM configuration to the UE (201), wherein the LTM configuration comprises a LTM-reference configuration. In an embodiment, the network apparatus (301) releases the LTM candidate configuration upon releasing the LTM-reference configuration, wherein the LTM candidate configuration is not a complete configuration. In an embodiment, the network apparatus (301) configures the UE (201) to maintain the LTM-reference configuration when the at least one LTM candidate configuration is configured in the UE (201), wherein the at least one LTM candidate configuration is not a complete configuration.

FIG. 6 illustrates a block diagram of a terminal (or a user equipment (UE)), according to embodiments of the present disclosure. FIG. 6 corresponds to the example of the UE of FIG. 2.

As shown in FIG. 6, the UE according to an embodiment may include a transceiver 610, a memory 620, and a processor 630. The transceiver 610, the memory 620, and the processor 630 of the UE may operate according to a communication method of the UE described above. However, the components of the UE are not limited thereto. For example, the UE may include more or fewer components than those described above. In addition, the processor 630, the transceiver 610, and the memory 620 may be implemented as a single chip. Also, the processor 630 may include at least one processor.

The transceiver 610 collectively refers to a UE receiver and a UE transmitter, and may transmit/receive a signal to/from a base station or a network entity. The signal transmitted or received to or from the base station or a network entity may include control information and data. The transceiver 610 may include a RF transmitter for up-converting and amplifying a frequency of a transmitted signal, and a RF receiver for amplifying low-noise and down-converting a frequency of a received signal. However, this is only an example of the transceiver 610 and components of the transceiver 610 are not limited to the RF transmitter and the RF receiver.

Also, the transceiver 610 may receive and output, to the processor 630, a signal through a wireless channel, and transmit a signal output from the processor 630 through the wireless channel.

The memory 620 may store a program and data required for operations of the UE. Also, the memory 620 may store control information or data included in a signal obtained by the UE. The memory 620 may be a storage medium, such as read-only memory (ROM), random access memory (RAM), a hard disk, a CD-ROM, and a DVD, or a combination of storage media.

The processor 630 may control a series of processes such that the UE operates as described above. For example, the transceiver 610 may receive a data signal including a control signal transmitted by the base station or the network entity, and the processor 630 may determine a result of receiving the control signal and the data signal transmitted by the base station or the network entity.

FIG. 7 illustrates a block diagram of a base station, according to embodiments of the present disclosure. FIG. 7 corresponds to the example of the network apparatus of FIG. 3.

As shown in FIG. 3, the base station according to an embodiment may include a transceiver 310, a memory 320, and a processor 330. The transceiver 310, the memory 320, and the processor 330 of the base station may operate according to a communication method of the base station described above. However, the components of the base station are not limited thereto. For example, the base station may include more or fewer components than those described above. In addition, the processor 330, the transceiver 310, and the memory 320 may be implemented as a single chip. Also, the processor 330 may include at least one processor.

The transceiver 310 collectively refers to a base station receiver and a base station transmitter, and may transmit/receive a signal to/from a terminal or a network entity. The signal transmitted or received to or from the terminal or a network entity may include control information and data. The transceiver 310 may include a RF transmitter for up-converting and amplifying a frequency of a transmitted signal, and a RF receiver for amplifying low-noise and down-converting a frequency of a received signal. However, this is only an example of the transceiver 310 and components of the transceiver 310 are not limited to the RF transmitter and the RF receiver.

Also, the transceiver 310 may receive and output, to the processor 330, a signal through a wireless channel, and transmit a signal output from the processor 330 through the wireless channel.

The memory 320 may store a program and data required for operations of the base station. Also, the memory 320 may store control information or data included in a signal obtained by the base station. The memory 320 may be a storage medium, such as read-only memory (ROM), random access memory (RAM), a hard disk, a CD-ROM, and a DVD, or a combination of storage media.

The processor 330 may control a series of processes such that the base station operates as described above. For example, the transceiver 310 may receive a data signal including a control signal transmitted by the terminal, and the processor 330 may determine a result of receiving the control signal and the data signal transmitted by the terminal.

In the afore-described embodiments of the present disclosure, elements included in the present disclosure are expressed in a singular or plural form according to the embodiments. However, the singular or plural form is appropriately selected for convenience of explanation and the present disclosure is not limited thereto. As such, an element expressed in a plural form may also be configured as a single element, and an element expressed in a singular form may also be configured as plural elements.

The foregoing description of the specific embodiments will so fully reveal the general nature of the embodiments herein that others can, by applying current knowledge, readily modify and or adapt for various applications such specific embodiments without departing from the generic concept, and, therefore, such adaptations and modifications are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-14. (canceled)

15. A method performed by a user equipment (UE) in a wireless communication system, the method comprising:
receiving, from a base station, a radio resource control (RRC) reconfiguration message including configuration information for a lower layer triggered mobility (LTM), wherein a reference configuration is included in the configuration information if a candidate configuration for at least one candidate cell is not a complete configuration; and
identifying whether to setup or release a previous configuration for each of the at least one candidate cell, based on the reference configuration.

16. The method of claim 15, further comprising identifying an RRC reconfiguration for the LTM based on whether the reference configuration is set to setup or release for the at least one candidate cell,
wherein the previous configuration is updated based on the identifying.

17. The method of claim 16, wherein, if the reference configuration is set to setup, the previous configuration is set to the reference configuration.

18. The method of claim 16, wherein, if the reference configuration is set to release, the previous configuration is deleted.

19. A method performed by a base station (BS) in a wireless communication system, the method comprising:
identifying whether to update a previous configuration associated with a lower layer triggered mobility (LTM); and
transmitting, to a user equipment (UE), a radio resource control (RRC) reconfiguration message including configuration information for the LTM,
wherein a reference configuration is included in the configuration information if a candidate configuration for at least one candidate cell is not a complete configuration, and
wherein the reference configuration is associated with identifying whether to setup or release the previous configuration for each of the at least one candidate cell.

20. The method of claim 19, wherein an RRC reconfiguration for the LTM is associated with the reference configuration that is set to setup or release.

21. The method of claim 20, wherein, if the reference configuration is set to setup, the previous configuration is set to the reference configuration.

22. The method of claim 20, wherein, if the reference configuration is set to release, the previous configuration is deleted.

23. A user equipment (UE) in a wireless communication system, the UE comprising:
at least one transceiver;
at least one processor communicatively coupled to the at least one transceiver; and
at least one memory, communicatively coupled to the at least one processor, storing instructions executable by the at least one processor individually or in any combination to cause the UE to:
receive, from a base station, a radio resource control (RRC) reconfiguration message including configuration information for a lower layer triggered mobility (LTM), wherein a reference configuration is included in the configuration information if a candidate configuration for at least one candidate cell is not a complete configuration, and
identify whether to setup or release a previous configuration for each of the at least one candidate cell, based on the reference configuration.

24. The UE of claim 23, wherein the instructions further cause the UE to identify an RRC reconfiguration for the LTM based on whether the reference configuration is set to setup or release for the at least one candidate cell, and
wherein the previous configuration is updated based on the identifying.

25. The UE of claim 24, wherein, if the reference configuration is set to setup, the previous configuration is set to the reference configuration.

26. The UE of claim 24, wherein, if the reference configuration is set to release, the previous configuration is deleted.

27. A base station (BS) in a wireless communication system, the BS comprising:
at least one transceiver;
at least one processor communicatively coupled to the at least one transceiver; and
at least one memory, communicatively coupled to the at least one processor, storing instructions executable by the at least one processor individually or in any combination to cause the base station to:
identify whether to update a previous configuration associated with a lower layer triggered mobility (LTM), and
transmit, to a user equipment (UE), a radio resource control (RRC) reconfiguration message including configuration information for the LTM,
wherein a reference configuration is included in the configuration information if a candidate configuration for at least one candidate cell is not a complete configuration, and
wherein the reference configuration is associated with identifying whether to setup or release the previous configuration for each of the at least one candidate cell.

28. The BS of claim 27, wherein an RRC reconfiguration for the LTM is associated with the reference configuration that is set to setup or release.

29. The BS of claim 28, wherein, if the reference configuration is set to setup, the previous configuration is set to the reference configuration.

30. The BS of claim 28, wherein, if the reference configuration is set to release, the previous configuration is deleted.
